(19) United States
(12) Patent Application Publication
(10) Pub. No.: US 2025/0262797 A1
(43) Pub. Date: Aug. 21, 2025

(54) Method of Manufacturing a Precast Concrete Utility Vault

(71) Applicants: Arthur Mulqueen, Seaford, NY (US); Leonard Burshtein, Plainview, NY (US)

(72) Inventors: Arthur Mulqueen, Seaford, NY (US); Leonard Burshtein, Plainview, NY (US)

(21) Appl. No.: 19/189,634

(22) Filed: Apr. 25, 2025

Related U.S. Application Data
(63) Continuation-in-part of application No. 18/491,400, filed on Oct. 20, 2023.

(51) Int. Cl. B28B 1/14; E02D 29/12

(52) U.S. Cl. CPC B28B 1/14; E02D 29/124; E02D 2250/0007; E02D 2250/0023; E02D 2300/002

(57) ABSTRACT

A method for manufacturing a precast concrete utility vault is disclosed, focusing on fabricating a single-piece, rectangular lower riser section using an upside-down monolithic pour of reinforced concrete. The method employs a formwork system configured to form a lower riser section with four walls, a slab section, and a sump channel, ensuring precise dimensions and high structural integrity. The upside-down pouring technique facilitates uniform concrete distribution and efficient curing, producing a robust vault component suitable for housing large electrical transformers. The method enhances manufacturing efficiency and product reliability through a streamlined, single-pour process.

### CROSS-REFERENCE TO RELATED APPLICATIONS

The present application claims priority to previously filed provisional patent application No. 63/590,298, filed on Oct. 13, 2023, and related U.S. patent application Ser. No. 18/491,400, filed on Oct. 20, 2023, directed to a precast concrete utility vault, the contents of which are incorporated herein by reference.

### FIELD

The present disclosure relates to methods of manufacturing precast concrete utility vaults, particularly those used to house large electrical transformers, such as 2500 kVA, 277/480V transformers. The vaults are typically, though not necessarily, located underground and manufactured using an upside-down pouring technique.

In this context, “underground” refers to vaults either completely below the surface of the surrounding terrain or partially below with a top or roof level with the terrain, often featuring a grate or opening in air communication with the surrounding environment. The surrounding terrain may be natural ground or a constructed surface, such as asphalt (e.g., a street or sidewalk).

### BACKGROUND

Precast concrete utility vaults are essential for securely housing utility components, such as large electrical transformers, underground or at ground level. These vaults must adhere to strict structural and dimensional standards to ensure safety, durability, and functionality under significant loads and environmental conditions. Conventionally, manufacturing such vaults involves multiple pouring steps or intricate formwork setups, which can introduce inconsistencies in concrete quality, increase production time, and elevate costs due to labor and material complexity.

The present invention introduces a method of manufacturing a precast concrete utility vault that overcomes these drawbacks by utilizing a single, upside-down monolithic pour. This technique ensures uniform concrete distribution across the lower riser section, reduces the likelihood of defects such as air pockets or weak seams, and achieves precise dimensional control. By forming the lower riser section—including its walls, slab, and sump channel—in one continuous pour, the method simplifies production while enhancing the vault's structural integrity. This approach is particularly advantageous for vaults intended to house large electrical transformers, where reliability, precision, and efficiency are critical. The upside-down orientation during pouring leverages gravity to optimize concrete placement, streamline the process, and produce a high-quality, single-piece component ready for assembly with an upper riser section.

### SUMMARY

The present invention provides a method for manufacturing a precast concrete utility vault, with a focus on fabricating the rectangular lower riser section as a single piece using an upside-down monolithic pour. The method comprises the following key steps:
1. Providing a Formwork System: A structural mold and forms are configured to define a rectangular lower riser section with four lower riser walls, a slab section, and a sump channel along one wall. The formwork ensures precise dimensions, including wall thickness (between about 8 and 12 inches), length (between about 10 and 14 feet), width (between about 10 and 12 feet), height (between about 5 and 7 feet), and features such as the upper section of the walls for engaging an upper riser section.
2. Orienting the Formwork System: The formwork is positioned in an upside-down configuration, allowing the concrete to be poured from what will become the bottom of the lower riser section, ensuring even distribution and structural consistency.
3. Performing a Monolithic Pour: A reinforced concrete mix, preferably 5,000 psi concrete with at least 650 pounds of cement per cubic yard, is poured into the formwork in a single, continuous operation. This eliminates joints and enhances durability.
4. Curing the Concrete: The concrete cures within the formwork under controlled conditions, yielding a robust, single-piece lower riser section.

Additional features of the method may include:
Dimensional Tolerances: The formwork maintains tolerances of ±0.25 inches for dimensions up to 5 feet, ±0.375 inches for dimensions between 5 and 10 feet, and ±0.50 inches for dimensions of 10 feet or more.
Reinforcement: Reinforcing bars of billet steel, wire-tied with plastic-coated tie wire and epoxy-coated, may be incorporated into the structural mold.
Wall Configurations: The upper section of the lower riser walls may include inner, middle, and outer portions or receiving portions to engage an upper riser section securely.

This method produces a lower riser section with exceptional structural integrity and dimensional accuracy, optimized for housing large electrical transformers. The upside-down pouring technique reduces manufacturing complexity, enhances efficiency, and ensures a reliable, high-quality product.

### BRIEF DESCRIPTION OF THE DRAWINGS

FIG. 1 shows a top view of the utility vault with a roof slab in place, as adapted from the prior vault application.

FIG. 2 shows a top view of the utility vault without a roof slab, illustrating the lower riser section's slab and sump channel.

FIGS. 3A and 3B depict the two-piece utility vault from perspectives A-A and C-C of FIG. 2, with FIG. 3C detailing conduit openings.

FIG. 4A shows the vault from perspective B-B of FIG. 2, with FIG. 4B enlarging detail A (construction joint).

FIGS. 5A-5C illustrate the upper and lower riser sections from perspectives A-A, B-B, and C-C of FIG. 2, with FIG. 5B showing the sump bottom.

FIGS. 6A-6C depict three embodiments of construction joints securing the upper and lower riser sections.

FIG. 7 demonstrates the steps for providing a framework system, pouring, and curing concrete in the formwork system.

### DETAILED DESCRIPTION

The following description, in conjunction with the accompanying drawings, details a method for manufacturing a precast concrete utility vault, focusing on the fabrication of the rectangular lower riser section using an upside-down monolithic pour. This method is designed to produce a robust, single-piece component suitable for housing large electrical transformers, such as 2500 kVA, 277/480V units.

### Overview of the Vault

A utility vault typically comprises a base (slab section), vertical walls forming a rectilinear shape, and a roof, creating an enclosure for utility components. The present method targets the lower riser section, which includes four walls and a slab with a sump channel, formed as a single piece in a controlled environment (e.g., a concrete plant) and later assembled with an upper riser section at the installation site.

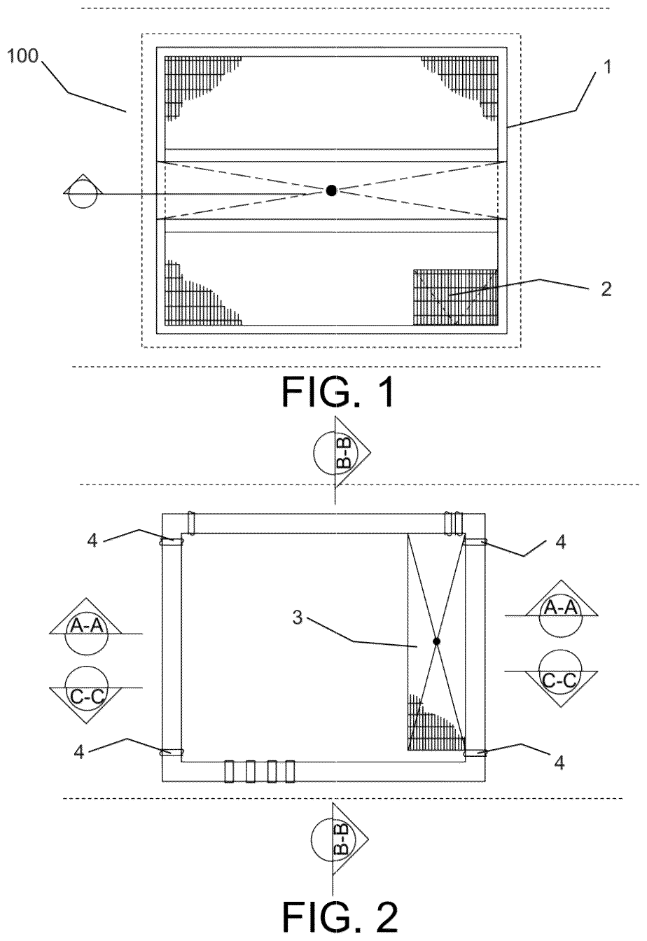

FIG. 1 depicts precast concrete utility vault 100 as seen from above, with rectangular upper riser section 1 and roof slab 2. Roof slab 2 may be solid but at least part may have a grate or similar feature to allow for passage of air.

FIG. 2 shows another top view of the present precast concrete utility vault, without a roof slab in place. Sump channel 3 in the floor of precast concrete utility vault 100 runs along one wall. One or more sump channel drains 4 facilitate the drainage of water from the vault.

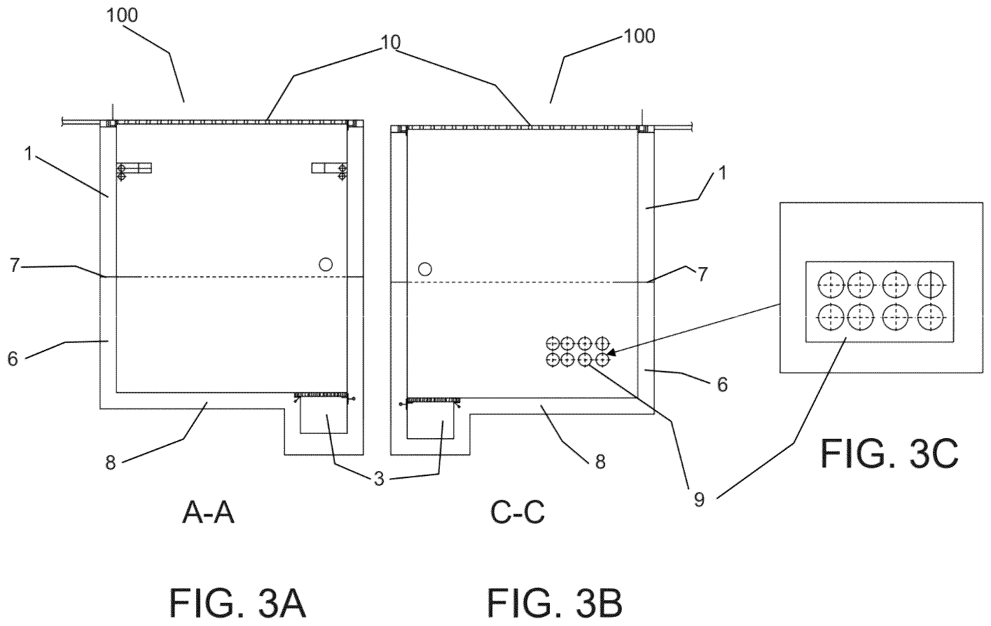

FIGS. 3A and 3B show the present precast concrete utility vault 100 from, respectively, perspectives A-A and C-C of FIG. 2. Both views include rectangular upper riser section 1, shown in a position in which it has been aligned with and placed on rectangular lower riser section 6; the upper and lower riser sections meet at construction joint 7. Grating 10 is present on a roof slab covering the upper riser section. Rectangular lower riser section 6 is formed with slab section 8, which constitutes a floor. Slab section 8 may include sump channel 3, shown as covered by a grate, which runs along most or all of one wall of rectangular lower riser section 6. A wall of rectangular lower riser section 6 may include a plurality of openings for conduits 9, also shown in FIG. 3C.

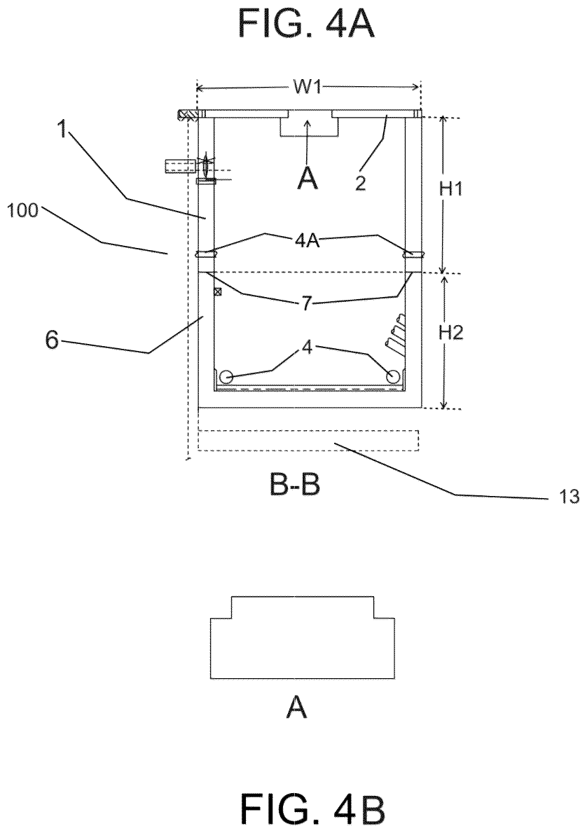

FIG. 4A shows the present precast concrete utility vault 100 from perspective B-B of FIG. 2, covered with roof slab 2. Rectangular upper riser section 1 has height H1, while rectangular lower riser section 6 has height H2; rectangular upper riser section 1 and rectangular lower riser section 6 each have width W1. Rectangular upper riser section 1 and lower riser section 6 are joined at construction joint 7. Rectangular upper riser section 1 includes sewer drains 4A, while lower riser section 6 includes sump channel drains 4. Also shown is sump bottom 13 of sump channel 3, which is not visible on this view. FIG. 4B shows detail A of FIG. 4A.

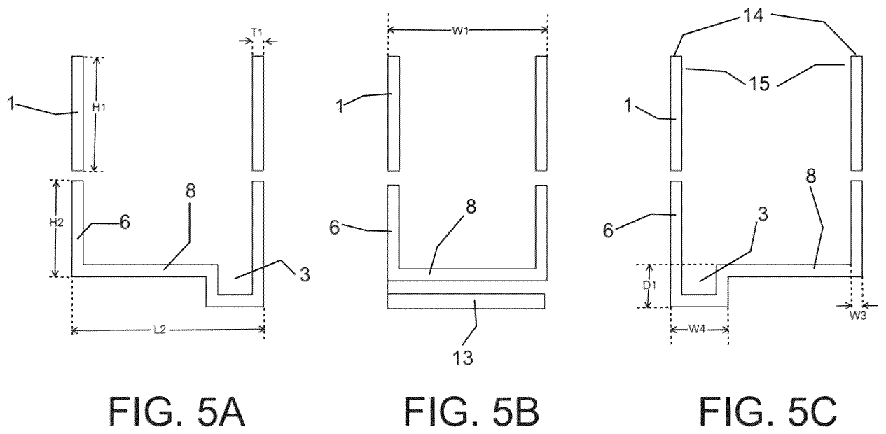

FIGS. 5A-5C are views of the present vault from three sides. If, for purposes of reference only, the side where sump channel 3 is located is designated as the rear, with the facing side being the front and the two other sides being left and right, FIG. 5A is a right side view showing rectangular upper riser section 1, having height H1 and wall thickness T1, and rectangular lower riser section 6 with slab section 8. Rectangular lower riser section 6 has height H2, measured as shown from the bottom of slab section 8 to the top of rectangular lower riser section 6, and length L2. FIG. 5B is a front view showing rectangular upper riser section 1, having height H1 and wall thickness T1, and rectangular lower riser section 6 with slab section 8 and showing sump channel bottom 13. FIG. 5C is a right side view showing rectangular upper riser section 1, including top surface 14 of top section of upper riser wall top section 15, and rectangular lower riser section 6 with slab section 8. Rectangular lower riser section 6 has wall thickness W3. FIG. 5C includes a side view of sump channel 3 having a depth D1 below the surface of slab section 8, and a width W4.

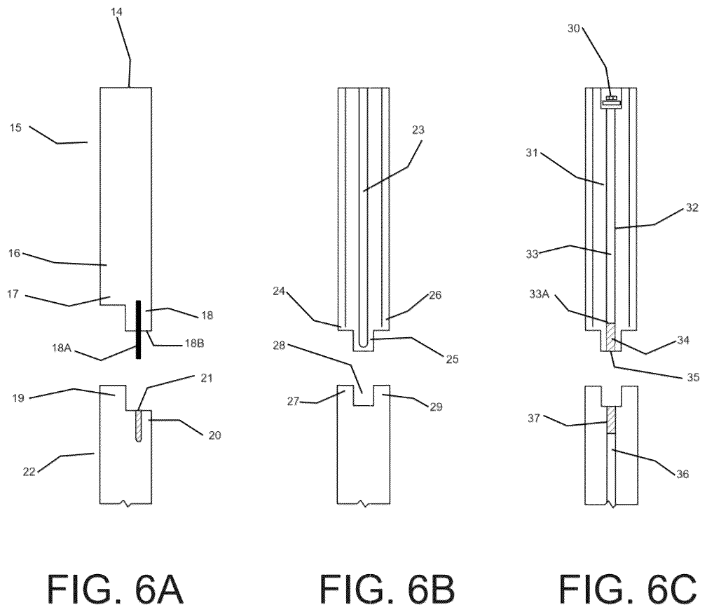

FIGS. 6A-6C show alternative construction joints for joining rectangular upper riser section 1 and rectangular lower riser section 6 when rectangular upper riser section 1 is aligned with and placed on rectangular lower riser section 6. FIG. 6A shows upper riser wall top section 15 having top surface 14. The lower or bottom section of the upper riser wall includes inner portion 17 and outer portion 18, which as seen extends below inner portion 17 by between about 4 inches and about 8 inches. Inner portion 17 and outer portion 18 may each have a thickness of between about 4.5 inches and 5.5 inches. Outer portion 18 includes a plurality of metal plates 18A that are each partially embedded therein, oriented coplanar with the upper riser wall, and having a thickness of between about 0.4 inches and 0.6 inches, a length of between about 11 inches and about 13 inches, and a height of between about 11 inches and about 13 inches. A portion of each metal plate 18A extends below bottom surface 18B of the bottom section of the upper riser wall by between about 5 inches and about 7 inches.

Also shown in FIG. 6A is lower riser wall upper/top section 22, with inner portion 19 and outer portion 20. Outer portion 20 includes a plurality of slots 21. As may be seen, inner portion 17 and outer portion 18 of the lower or bottom section of the upper riser wall are complementary to, or mirror images of, inner portion 19 and outer portion 20 of lower riser wall upper section 22, and each of slots 21 in outer portion 20 of lower riser wall upper section 22 are complementary to the portion of each metal plate 18A that extends below bottom surface 18B of the bottom section of the upper riser wall. It will be appreciated that when rectangular upper riser section 1 is aligned with and placed on rectangular lower riser section 6, their respective inner and outer sections will mesh or match, and the extended portions of metal plates 18A will be inserted into slots 21, securing the upper riser section and bottom riser section together.

FIG. 6B similarly shows a portion of a bottom section of the upper riser wall and an upper portion of the lower riser wall. The upper riser wall contains a plurality of reinforcing bars, or “rebar”, 23. The bottom section of the upper riser wall includes inner portion 24, middle portion 25, and outer portion 26. The upper portion of the lower riser wall includes corresponding inner portion 27, middle portion 28, and outer portion 29. It will be appreciated that, as the upper riser section is placed on the lower riser section, middle portion 25 of the upper riser section will enter middle portion 28 of the lower riser section, and the facing surfaces of the respective inner and outer portions will meet, securing the upper riser section and bottom riser section together. In this embodiment the middle of the upper riser wall may include a rebar that extends into middle portion 25, providing additional strength and stability when the upper riser section and bottom riser section are joined.

FIG. 6C show another construction joint, similar to that shown in FIG. 6B. Here, the upper riser wall includes a central cylindrical aperture 31, which contains rigid plastic sleeve 32; any suitable plastic may be used, including polyvinyl chloride (PVC). Cylindrical aperture 31 extends from an aperture located in a recess in the top section of the upper riser wall, to another aperture 35 in the bottom of the middle portion of the bottom section of the upper riser wall. First coil rod 33 is located within rigid plastic sleeve 32, and includes coil nut 30 located at its top within the recess as shown, while coil rod bottom 33A of first coil rod 33 includes externally threaded portion 34, which can be extended through aperture 35. The middle portion of the upper portion of the lower riser wall includes second coil rod 36, having internally threaded portion 37 at its upper end. It will again be appreciated that, as the upper riser section is placed on the lower riser section, the middle portion of the upper riser section will enter the middle portion of the lower riser section, and the facing surfaces of the respective inner and outer portions will meet. Coil nut 30 may then be manipulated to extend externally threaded portion 34 of coil rod 33 through aperture 35 and into internally threaded portion 37 of second coil rod 36, and rotated to thread externally threaded portion 34 into internally threaded portion 37, thereby further securing the upper riser section and bottom riser section together.

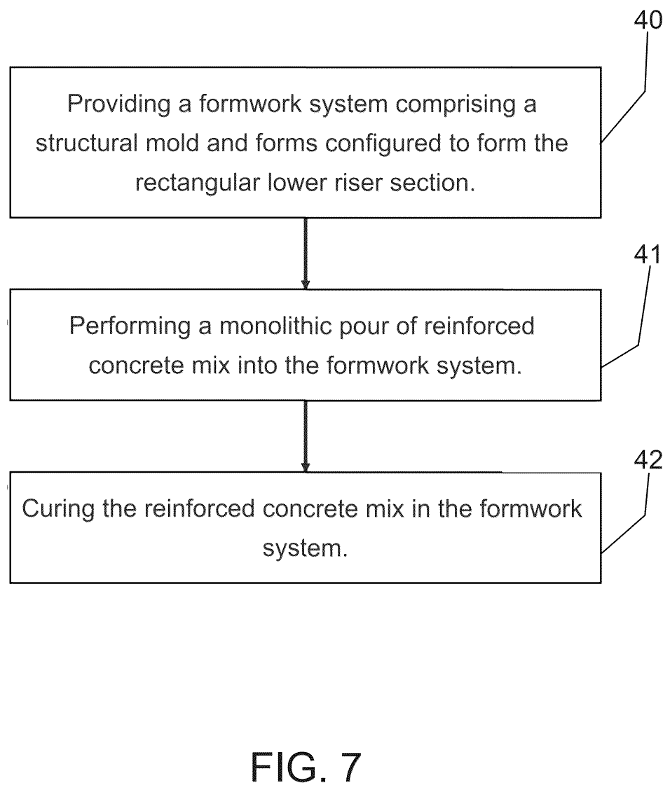

FIG. 7 FIG. 1 is a flowchart illustrating a method for providing a formwork system for the fabrication of a precast concrete utility vault, according to an embodiment. At step 40, the formwork system is provided, comprising a structural mold and forms configured to form the rectangular lower riser section. The formwork system is oriented in an upside-down configuration to facilitate the casting process. The structural mold is formed using reinforcing bars of billet steel, which are wire-tied at all contact points with plastic-coated tie wire and epoxy coated, to provide additional strength and stability. The formwork system is configured to form the upper section of the lower riser walls with an outer portion and an inner portion, ensuring that the structural integrity and dimensional accuracy are maintained.

The formwork system is also configured to form a sump channel with a specific depth and width, which facilitates the drainage of water and prevents water accumulation in the vault. Additionally, the formwork system is configured to provide each upper section of the lower riser walls with an inner portion, a middle portion, and an outer portion, with the middle portion being recessed and having a width that allows for the inclusion of a plurality of cylindrical apertures. These apertures are designed to contain coil rods, which facilitate the joining of riser sections. The formwork system has dimensional tolerances to ensure that the lower riser section is formed with precision, contributing to the overall structural integrity of the utility vault.

In step 41, the process involves performing a monolithic pour of reinforced concrete mix into the formwork system. This step ensures the integrity and strength of the lower riser section of the utility vault. The reinforced concrete mix, specified as 5,000 psi concrete, is prepared using at least 650 pounds of cement per cubic yard. This preparation ensures that the concrete achieves the desired strength and durability necessary for the structural demands of the utility vault. The monolithic pour involves a continuous and uninterrupted pouring process, which helps in minimizing the formation of joints or weak points within the concrete structure. This method creates a single-piece, precast concrete rectangular lower riser section that is robust and capable of withstanding the environmental and load conditions it may encounter. The reinforced concrete mix is poured into the formwork system, which is configured to form the lower riser section with precise dimensions and features, such as the sump channel and cylindrical apertures. The formwork system is oriented in an upside-down configuration to facilitate the pouring process and ensure that the concrete fills all areas of the mold uniformly. This step is followed by the curing process, which is critical in achieving the final strength and stability of the concrete structure. The curing process involves maintaining the concrete at a suitable temperature and humidity level to allow the cement to hydrate properly, thereby enhancing the overall durability and longevity of the utility vault.

In step 42, the curing of the reinforced concrete mix within the formwork system is undertaken. This process involves allowing the concrete to set and gain strength over time, ensuring the structural integrity of the lower riser section. The curing process achieves the desired properties of the concrete, such as its compressive strength and durability. The formwork system, which has been previously oriented in an upside-down configuration, provides the necessary support and shape for the concrete as it cures. The reinforced concrete mix, which has been poured monolithically into the formwork system, consists of a specific composition, including 5,000 psi concrete prepared with at least 650 pounds of cement per cubic yard. This composition contributes to the overall strength and stability of the lower riser section once the curing process is complete. The curing process is conducted in a controlled environment to minimize the presence of air pockets, excess moisture, and other contaminants that could compromise the quality of the concrete. The curing time and conditions, such as temperature and humidity, are carefully managed to ensure optimal results. The cured lower riser section is then ready for further processing or assembly as part of the utility vault system.

For each of the construction joints described herein, a bonding or similar compound, such as uniweld bonding compound, may be applied to the facing surfaces of the upper riser section and/or of the lower riser section prior to placing the upper riser section on the lower riser section.

### 1. Providing a Formwork System

The process begins with a formwork system comprising a structural mold and forms tailored to create the lower riser section with:
Four Lower Riser Walls: Thickness between about 8 and 12 inches, length between about 10 and 14 feet, width between about 10 and 12 feet, and height between about 5 and 7 feet.
Slab Section: Joins the four walls, featuring an upper surface and a sump channel along one wall (depth between about 1.5 and 2.5 feet, width between about 2 and 3 feet).
Upper Section of Walls: Configured for engagement with an upper riser section, potentially including inner and outer portions (inner portion extending 4-8 inches beyond outer, thickness 4.5-5.5 inches) or receiving portions (e.g., slots or recessed middle portions).

The formwork ensures dimensional precision with tolerances of:
±0.25 inches for dimensions ≤5 feet.
±0.375 inches for dimensions >5 feet and <10 feet.
±0.50 inches for dimensions ≥10 feet.

Reinforcing bars (e.g., billet steel rebar, 0.5-inch diameter), wire-tied with plastic-coated tie wire and epoxy-coated, may be embedded within the mold for added strength.

### 2. Orienting the Formwork System

The formwork is oriented upside-down. In this configuration, the slab section forms the top of the mold, and the open top of the lower riser section (which will face upward in the final vault) is at the bottom during pouring. This orientation allows concrete to flow downward from the slab into the wall forms, ensuring uniform distribution and minimizing voids.

### 3. Performing a Monolithic Pour

A reinforced concrete mix-preferably 5,000 psi concrete with at least 650 pounds of cement per cubic yard-is poured into the upside-down formwork in a single, continuous operation. The pour begins at the slab section, filling the mold downward through the wall forms. This monolithic approach eliminates seams, enhancing structural integrity, and leverages gravity to settle the concrete evenly across all features, including the sump channel and wall configurations.

### 4. Curing the Concrete

After pouring, the concrete cures within the formwork under controlled conditions (e.g., regulated temperature and humidity) to minimize defects like air pockets or shrinkage cracks. The result is a single-piece lower riser section with a weight of about 50,000 to 65,000 pounds, ready for transport and assembly.

### Additional Features and Configurations

The method may incorporate:
Sump Channel: Formed with precise depth (1.5-2.5 feet) and width (2-3 feet) via formwork inserts.
Wall Engagement Features: The upper section may include:
Inner and outer portions (inner extending 4-8 inches beyond outer, thickness 4.5-5.5 inches).
Inner, middle, and outer portions (middle recessed 3.5-4.5 inches below inner/outer, width 3-4 inches), with optional cylindrical apertures (diameter 0.75-1.5 inches) for securing mechanisms (e.g., coil rods).
Receiving portions (e.g., slots for metal plates from the upper riser section).
Reinforcement: Rebar placement ensures durability under transformer loads and environmental stresses.

The upside-down monolithic pour provides:
Structural Integrity: Seamless construction withstands significant loads.
Precision: Tight tolerances ensure compatibility with upper riser sections.
Efficiency: Single-pour process reduces time and labor compared to multi-step methods.
Adaptability: Formwork adjustments allow for various wall and sump configurations.

### Assembly Context

Post-curing, the lower riser section is transported to the installation site, positioned, and joined with an upper riser section (e.g., via construction joints as in FIGS. 6A-6C), completing the vault.

By the present disclosure a method of manufacturing a precast concrete utility vault's lower riser section using an upside-down monolithic pour has been described. By integrating precise formwork, reinforcement, and controlled curing, the method provides a durable, dimensionally accurate product optimized for housing large electrical transformers.

While the present method has been described with reference to particular embodiments, it will be understood by those skilled in the art that various changes may be made and equivalents may be substituted for elements thereof without departing from the intended scope. In addition, modifications may be made to adapt a particular situation or material to these teachings without departing from the intended scope.

Therefore, it is intended that the scope not be limited to the particular embodiments disclosed herein, but rather will include all embodiments falling within the scope and spirit of the appended claims.

What I/we claim is:

1. A method of fabricating a single-piece, precast concrete rectangular lower riser section for a utility vault, said rectangular lower riser section comprising four lower riser walls joined by a slab section, said slab section having an upper surface and a sump channel along one of said lower riser walls, said method comprising:
a) providing a formwork system comprising a structural mold and forms configured to form:
i) said rectangular lower riser section with four lower riser walls having:
A) a thickness of between about 8 inches and 12 inches,
B) a length of between about 10 feet and 14 feet,
C) a width of between about 10 feet and 12 feet,
D) a height of between about 5 feet and 7 feet,
E) an upper section, and
F) a top surface;
ii) a slab section joining said four lower riser walls and having an upper surface and a sump channel along one of said lower riser walls;
b) orienting said formwork system in an upside-down configuration;
c) performing a monolithic pour of reinforced concrete mix into said formwork system; and,
d) curing said reinforced concrete mix in said formwork system.

2. The method of claim 1, further wherein said formwork system has dimensional tolerances of:
a) plus or minus 0.25 inches for any lower riser section dimension of five feet or less,
b) plus or minus 0.375 inches for any lower riser section dimension greater than five feet and less than ten feet, and
c) plus or minus 0.50 inches for any lower riser section dimension of ten feet or greater.

3. The method of claim 2 wherein said structural mold is formed using reinforcing bars of billet steel that are wire-tied at all contact points with plastic-coated tie wire and epoxy coated.

4. The method of claim 1, further wherein said formwork system is configured to form said upper section of said lower riser walls with an outer portion and an inner portion, said inner portion extending between about 4 inches and about 8 inches beyond said outer portion and having a thickness of between about 4.5 inches and 5.5 inches.

5. The method of claim 4 wherein said wherein said formwork system is configured to form said sump channel with a depth of between about 1.5 feet and about 2.5 feet below said upper surface and a width of between about 2 feet and about 3 feet.

6. The method of claim 1 where said formwork system is configured to provide each of said upper sections of said lower riser walls with an inner portion, a middle portion, and an outer portion, said middle portion being recessed between about 3.5 inches and about 4.5 inches below each of said inner portion and said outer portion and having a width of between about 3 inches and about 4 inches.

7. The method of claim 6 where said formwork system is configured to provide said middle portion with a plurality of cylindrical apertures positioned centrally therein and having a diameter of between about 0.75 inches and about 1.5 inches, each of said cylindrical apertures having an upper end terminating at an opening in said middle portion and extending vertically downward through said lower riser wall.

8. The method of claim 1, wherein said reinforced concrete mix is 5,000 psi concrete.

9. The method of claim 8, wherein said reinforced concrete mix is prepared using at least 650 pounds of cement per cubic yard.

10. A method of fabricating a single-piece, precast concrete rectangular lower riser section for a utility vault, said rectangular lower riser section comprising four lower riser walls joined by a slab section, said slab section having an upper surface and a sump channel along one of said lower riser walls, said method comprising:
a) providing a formwork system comprising a structural mold and forms configured to form:
i) said rectangular lower riser section with four lower riser walls having:
A) a thickness of between about 8 inches and 12 inches,
B) a length of between about 10 feet and 14 feet,
C) a width of between about 10 feet and 12 feet,
D) a height of between about 5 feet and 7 feet,
E) an upper section, and
F) a top surface;
wherein said top surface of said bottom riser walls comprises a plurality of receiving portions aligned and configured to correspond to a plurality of projecting portions in an upper riser section so that, when the upper riser section is aligned with and placed on said lower riser section, each of said plurality of receiving portions and the plurality of projecting portions engages with each other to secure said lower riser section and the upper riser section to each other;
b) orienting said formwork system in an upside-down configuration;
c) performing a monolithic pour of reinforced concrete mix into said formwork system; and,
d) curing said reinforced concrete mix in said formwork system.

11. The method of claim 10, further wherein said formwork system has dimensional tolerances of:
a) plus or minus 0.25 inches for any lower riser section dimension of five feet or less,
b) plus or minus 0.375 inches for any lower riser section dimension greater than five feet and less than ten feet, and
c) plus or minus 0.50 inches for any lower riser section dimension of ten feet or greater.

12. The method of claim 11 wherein said structural mold is formed using reinforcing bars of billet steel that are wire-tied at all contact points with plastic-coated tie wire and epoxy coated.

13. The method of claim 10, further wherein said formwork system is configured to form said upper section of said lower riser walls with an outer portion and an inner portion, said inner portion extending between about 4 inches and about 8 inches beyond said outer portion and having a thickness of between about 4.5 inches and 5.5 inches.

14. The method of claim 13 wherein said formwork system is configured to form said sump channel with a depth of between about 1.5 feet and about 2.5 feet below said upper surface and a width of between about 2 feet and about 3 feet.

15. The method of claim 10 where said formwork system is configured to provide each of said upper sections of said lower riser walls with an inner portion, a middle portion, and an outer portion, said middle portion being recessed between about 3.5 inches and about 4.5 inches below each of said inner portion and said outer portion and having a width of between about 3 inches and about 4 inches.

16. The method of claim 15 where said formwork system is configured to provide said middle portion with a plurality of cylindrical apertures positioned centrally therein and having a diameter of between about 0.75 inches and about 1.5 inches, each of said cylindrical apertures having an upper end terminating at an opening in said middle portion and extending vertically downward through said lower riser wall.

17. The method of claim 10, wherein said reinforced concrete mix is 5,000 psi concrete.

18. The method of claim 17, wherein said reinforced concrete mix is prepared using at least 650 pounds of cement per cubic yard.
